(19) United States
(12) Patent Application Publication
(10) Pub. No.: US 2019/0258018 A1
(43) Pub. Date: Aug. 22, 2019

(54) LENS UNIT

(71) Applicant: NIDEC SANKYO CORPORATION, Nagano (JP)

(72) Inventor: Toshio SHIROTORI, Nagano (JP)

(21) Appl. No.: 16/277,117

(22) Filed: Feb. 15, 2019

(30) Foreign Application Priority Data
Feb. 19, 2018 (JP) 2018-027004
Dec. 6, 2018 (JP) 2018-229133

(51) Int. Cl. G02B 7/02; G02B 9/60; H04N 5/225

(52) U.S. Cl. CPC G02B 7/021; H04N 5/2254; G02B 9/60

(57) ABSTRACT

A lens unit may include a first lens closest to an object side; a plurality of lenses at an imaging side of the first lens; and a lens tube holding the first lens and the plurality of lenses. The lens tube may include a first lens tube portion holding the first lens and a second lens tube portion holding the plurality of lenses. The lens tube may include a circumferential groove recessed between an inner circumference of the second lens tube portion and an outer circumference of the lens tube. When viewed in a direction perpendicular to an optical axis, a bottom of the circumferential groove may be located at the imaging side in a depth that is more than a thickness of a second lens in a direction of the optical axis, the second lens being located closest to the object side among the plurality of lenses.

### CROSS REFERENCE TO RELATED APPLICATION

The present application claims priority under 35 U.S.C. § 119 to Japanese Application No. 2018-027004 filed Feb. 19, 2018 and Japanese Application No. 2018-229133, filed Dec. 6, 2018, the entire contents of which are incorporated herein by reference.

### BACKGROUND

At least an embodiment of the present invention relates to a lens unit including a plurality of lenses and a lens tube holding the lenses.

Some of the known lens units include a plurality of lenses and a lens tube (lens barrel) holding the lenses and have at least one of the lenses pressed into and supported by the inner circumference of the lens tube. In recent years, there has been an increasing demand for a higher resolution in the market of lens units. To obtain a higher resolution, the accuracy with which a lens is held in a lens tube is important. Typically, a lens tube is formed of a resin material, and a high accuracy of the roundness of the inner circumference, a tube portion, of the lens tube is of importance; however, the thick wall of the lens tube causes noticeable sink marks during molding. Generally, the first lens located closest to the object side hardly affects the optical performance. Therefore, in disclosed technologies, the occurrence of sink marks is effectively prevented by providing a circumferential groove having a recess extending from the imaging side toward the object side on the outer side of the tube portion in which the second and subsequent lenses are disposed (for example, see Japanese Laid-open Patent Publication No. 2017-53932 and Japanese Laid-open Patent Publication No. 2017-53933).

Although there is a demand for a further size reduction, a groove formed at the imaging side results in little space for alignment with a higher-level device, such as an imaging device, imposes more constraints on design, and therefore puts limitations to cope with a demand for a size reduction; thus, there is a need for a new technology.

### SUMMARY

At least an embodiment of the present invention has been made in consideration of the above circumstances and has an object to provide a lens unit to improve the roundness of the inner circumference of a lens tube (lens barrel) and ensure spaces for alignment with a higher-level device, such as an imaging device.

A lens unit according to at least an embodiment of the present invention includes: a first lens located closest to an object side; a plurality of lenses located at an imaging side of the first lens; and a lens tube holding the first lens and the plurality of lenses, wherein the lens tube includes a first lens tube portion holding the first lens and a second lens tube portion holding the plurality of lenses, the lens tube is provided with a circumferential groove recessed between an inner circumference of the second lens tube portion and an outer circumference of the lens tube and extending from the object side toward the imaging side, and, when viewed in a direction perpendicular to an optical axis, a bottom of the circumferential groove is located at the imaging side in a depth that is more than a thickness of a second lens in a direction of the optical axis, the second lens being located closest to the object side among the plurality of lenses.

Formation of the circumferential groove extending from the object side makes it possible to ensure spaces in the lens tube at the imaging side. As spaces for alignment with a higher-level device such as an imaging device may be thus ensured, it is possible to cope with a demand for a size reduction. Furthermore, as the circumferential groove extending from the object side is formed and the bottom of the circumferential groove is located at the imaging side in a depth that is more than the thickness of at least the second lens in the direction of the optical axis, sink marks on the part holding the second lens in the second lens tube portion may be prevented, and a higher resolution may be achieved.

The plurality of lenses held by the second lens tube portion may be swaged and fixed by a swaging portion formed at an end of the second lens tube portion in the direction of the optical axis.

The plurality of lenses may include the second lens, a third lens located second closest to the object side after the second lens, and an imaging-side lens located at the imaging side of the third lens, and a bottom surface of the circumferential groove may be located at the imaging side in a depth that is more than a thickness of the third lens in the direction of the optical axis.

A gate mark formed when the lens tube is produced and indicating an injection position of resin may be formed outward of the circumferential groove in a radial direction, and the bottom of the circumferential groove may be located at the imaging side of a press area of a lens that is located closest to the imaging side among the plurality of lenses and pressed into the inner circumference of the second lens tube portion.

This configuration may prevent unevenness of resin due to the flow of resin during injection molding directly affecting the press area of a lens. That is, a high-accurate roundness is possible.

The plurality of lenses located on an inner side of the circumferential groove may be secured in position in the direction of the optical axis by a placement surface formed at the object side of the bottom surface of the circumferential groove.

The placement surface located at the object side of the bottom surface of the circumferential groove may prevent a reduction in the surface accuracy, such as sink marks.

The first lens tube portion may include a protruding portion that protrudes toward the circumferential groove (i.e., a side in the radial direction), and the first lens may be secured in position by the protruding portion.

The lens tube may be formed by integrating a chassis and a lens holder.

The lens tube may include: a lens-tube main body including the first lens tube portion and the second lens tube portion and having the circumferential groove formed therein; a top board portion connected to the lens-tube main body at the object side; a skirt portion surrounding the lens-tube main body around the optical axis in a direction thereof at the imaging side of the top board portion and connected to the top board portion; and a plurality of plate-like ribs connecting the top board portion, the skirt portion, and the lens-tube main body at the imaging side of the top board portion and including a rib bottom that is located at the object side of a bottom of the lens-tube main body, the ribs being separately formed at areas in a circumferential direction around the optical axis.

Because of this lightening conducted on the lens tube to partially form the ribs, the lens tube or the lens unit is lightweight, while the mechanical strength of the lens tube is maintainable with the ribs.

The skirt portion may have an inner surface having substantially a rectangular shape when viewed in the direction of the optical axis, and when viewed in the direction of the optical axis, the ribs may be formed along at least a diagonal line of the substantially rectangular shape and a straight line connecting centers of opposing sides.

When the skirt portion has an inner surface having substantially a rectangular shape, the ribs formed along the diagonal line and the straight line connecting the centers of opposing sides are particularly effective in the mechanical strength of the lens tube.

In an area where the rib is not formed when viewed in the direction of the optical axis, the lens-tube main body may be provided with, at the object side of the rib bottom, a tilted portion in which an outer diameter of the lens-tube main body is gradually larger as approaching toward the top board portion than at the imaging side.

The provision of the tilted portion improves the mechanical strength of the part connecting the rib, the lens-tube main body, and the top board portion or the lens-tube main body at the object side and suppresses the occurrence of sink marks in the lens-tube main body.

The rib bottom may be located at the object side of the bottom of the circumferential groove.

As the rib bottom of the rib is located at the object side of the bottom of the circumferential groove, the path length for the flow of resin during molding even at the area of the rib is long, whereby a decrease in the surface accuracy, such as sink marks, may be prevented in the lens tube having the rib disposed therein.

A gate mark may be formed near an end of an outer frame of the lens tube at the imaging side, the gate mark being formed when the lens tube is molded with resin.

This allows a long distance from the gate, through which resin is injected during resin molding, to the second lens tube portion and enables equalization of the flow of resin in the second lens tube portion.

According to at least an embodiment of the present invention, the circumferential groove extending from an object and formed between the first lens tube portion and the second lens tube portion in the lens tube may ensure spaces in the lens tube at the imaging side. As spaces for alignment with a higher-level device such as an imaging device may be thus ensured, it is possible to cope with a demand for a size reduction. Furthermore, as the circumferential groove extending from the object side is formed and the bottom of the circumferential groove is located at the imaging side in a depth that is more than the thickness of at least the second lens in the direction of the optical axis, sink marks on the part holding the second lens in the second lens tube portion may be prevented and a higher resolution may be achieved.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a perspective view of a lens unit according to an embodiment;

FIG. 2 is a cross-sectional perspective view of the lens unit according to the embodiment;

FIG. 3 is a cross-sectional perspective view of a lens tube according to the embodiment;

FIG. 4 is a longitudinal sectional view of the lens unit according to the embodiment;

FIG. 5 is a cross-sectional view of the lens tube according to the embodiment;

FIG. 6 is a diagram that shows a bottom of a first lens tube portion when viewed from an object side according to the embodiment;

FIG. 7 is a diagram that shows a cross-sectional structure of a circumferential groove according to the embodiment;

FIG. 8 is a diagram that shows a cross-sectional structure of the circumferential groove according to a modification 1 of the embodiment;

FIG. 9 is a diagram that shows a cross-sectional structure of the circumferential groove according to a modification 2 of the embodiment;

FIG. 10 is a cross-sectional view of a lens unit according to a modification 3 of the embodiment;

FIG. 11 is a perspective view of a lens tube according to a modification 4 of the embodiment; and

FIG. 12A and FIG. 12B are cross-sectional views along the optical axis of the lens unit according to the modification 4 of the embodiment. FIG. 12A illustrates an area where a rib is provided and FIG. 12B illustrates an area where no rib is provided.

### DETAILED DESCRIPTION

With reference to drawings, a detailed explanation is given below of an embodiment of the present invention.

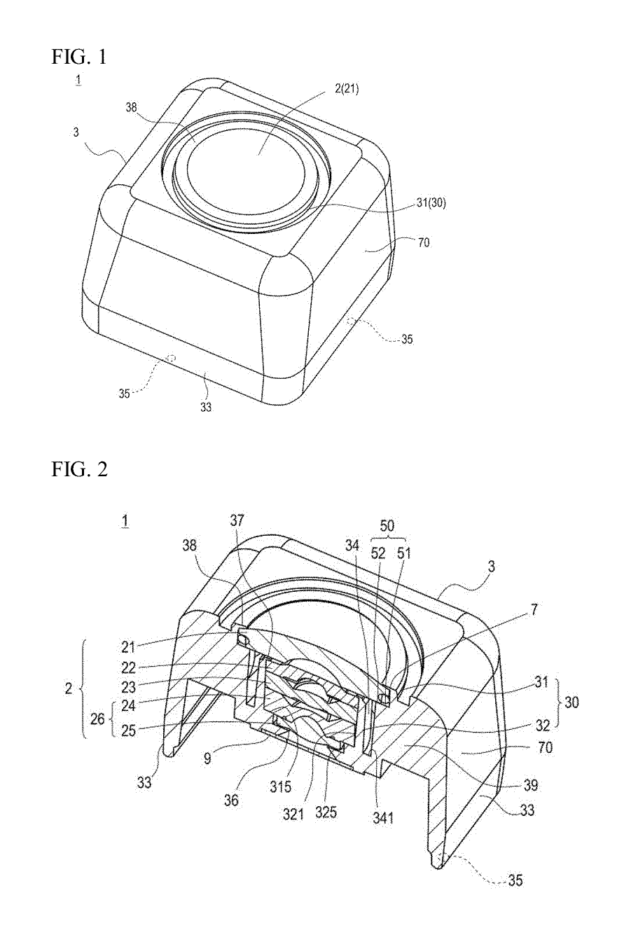

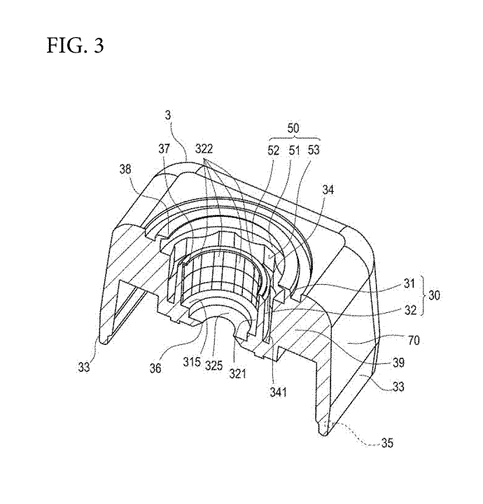

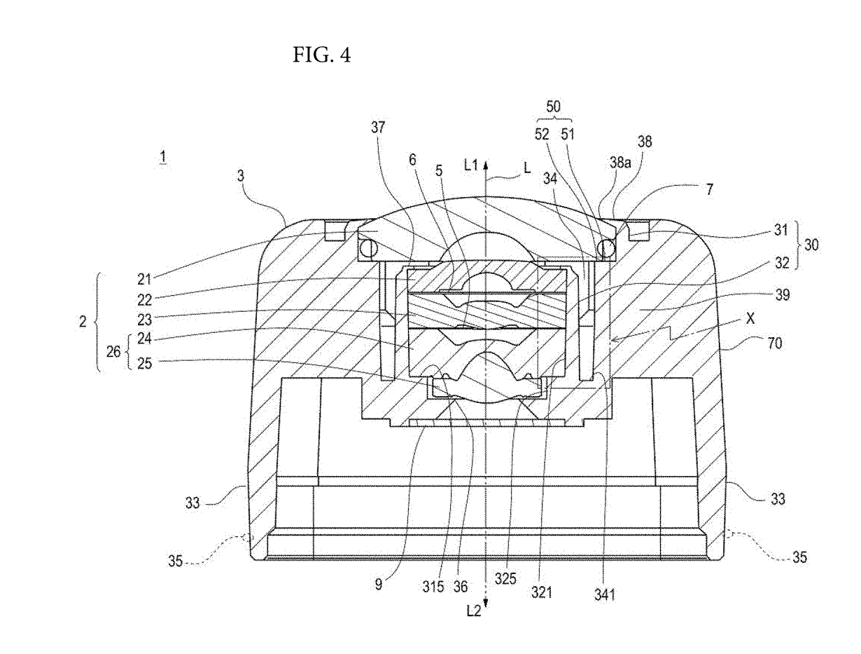

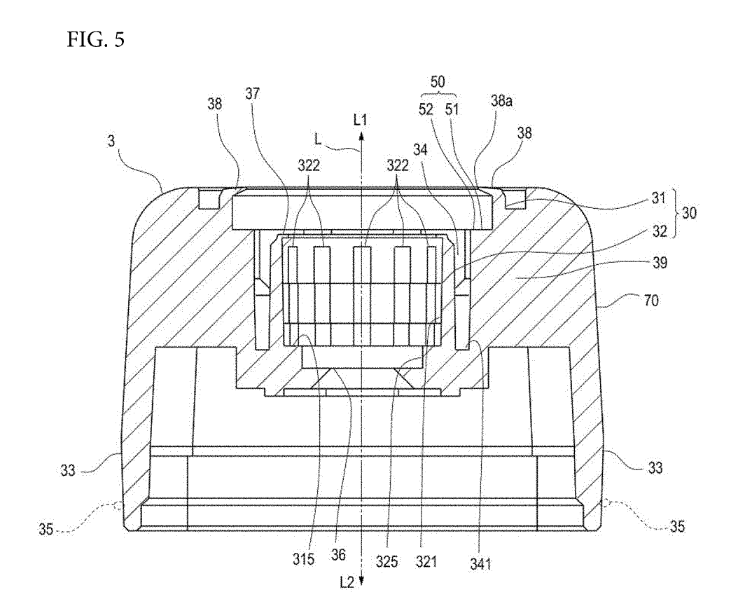

FIG. 1 is a perspective view of a lens unit 1 according to the present embodiment when viewed from an object side L1. FIG. 2 is a cross-sectional perspective view of the lens unit 1. FIG. 3 is a cross-sectional perspective view of the lens tube 3, in which a wide-angle lens 2 in FIG. 2 is omitted. FIG. 4 is a longitudinal sectional view of the lens unit 1. FIG. 5 is a cross-sectional view of the lens tube 3, in which the wide-angle lens 2 in FIG. 4 is omitted.

As shown, the lens unit 1 includes a group of lenses constituting the wide-angle lens 2 and the lens tube 3 accommodating the wide-angle lens 2. The lens tube 3 is formed by integrating what is called a lens holder and a chassis.

### Configuration of the Lens

Each piece of the wide-angle lens 2 has a disk-like shape with a circular circumferential edge, is arranged side by side at the same axis, and performs a wide-angle lens function in whole. Specifically, the wide-angle lens 2 is composed of, sequentially from the object side L1, a first lens 21, a second lens 22, a third lens 23, a fourth lens 24, and a fifth lens 25. The fourth lens 24 and the fifth lens 25 are bonded together to form a cemented lens 26.

In the cemented lens 26, the fifth lens 25 is composed of a lens having a positive power, and the fourth lens 24 is composed of a lens having a negative power. Furthermore, the third lens 23 is composed of a lens having a positive power, and the first lens 21 and the second lens 22 are composed of a lens having a negative power.

An aperture 5 is disposed between the fourth lens 24 and the third lens 23, and a light shielding plate 6 is disposed between the third lens 23 and the second lens 22 (see FIG. 4). Furthermore, an infrared cut filter 9 is disposed at an opening 36 on an imaging side L2 of the cemented lens 26 provided in the end at the imaging side L2 so as to cover the opening 36.

The group of lenses constituting the wide-angle lens 2 are accommodated in the lens tube 3 from the object side L1; therefore, the outer diameters of the first lens 21, the second lens 22, the third lens 23, the fourth lens 24, and the fifth lens 25 are gradually smaller in this order. Each of the first to the fifth lenses 21 to 25 is made of a glass lens or a plastic lens. In this configuration, the first lens 21 is a glass lens, and the second to the fifth lenses 22 to 25 are plastic lenses.

### Configuration of the Lens Tube 3

The lens tube 3 is a resin molded object, and it includes: a lens-tube main body 30 including a lens chamber to accommodate the wide-angle lens 2; and a rectangular skirt portion 33 extending from an outer circumference (outer frame) 70 of the lens-tube main body 30 toward the imaging side L2, the lens-tube main body 30 and the skirt portion 33 being integrally formed. The skirt portion 33 is part of the configuration to perform principally the function of a lens chassis. A gate mark 35 is formed near an end of each side surface of the skirt portion 33 at the imaging side L2. Specifically, in the mold used when the lens tube 3 is molded with resin, a gate port for injecting a liquid resin material is disposed at the position corresponding to the area where the gate mark 35 is formed.

Specifically, the lens-tube main body 30 is provided with the inner circumference (the lens chamber) extending toward the imaging side L2 along the outer circumference of each of the lenses constituting the wide-angle lens 2. Here, a first lens tube portion 31 at the object side L1 and a second lens tube portion 32 at the imaging side L2 are formed such that their inner circumferences (i.e., the lens chamber) communicate with each other, and the outer circumference side of the second lens tube portion 32 is a thick-walled portion 39. A bottom 50, which is a flat surface formed at the end of the first lens tube portion 31 at the imaging side L2, connects to the end of the second lens tube portion 32 at the object side L1 in a stepwise fashion.

As described later in detail, the bottom 50 is provided with a circular circumferential groove 34 having a recess extending in a predetermined depth from the object side L1 toward the imaging side L2 such that it surrounds the opening of the second lens tube portion 32 at the object side L1.

At the inner circumference side of the first lens tube portion 31, the bottom 50 is provided with a circular flat surface 51, a plurality of protruding portions (bulging portions) 52 protruding (bulging) from the flat surface 51 toward the circumferential groove 34 (i.e., the inner side in a radial direction); and a plurality of recessed portions 53 between the protruding portion 52 and the protruding portion 52.

The first lens 21 with an O-ring sealing member 7 fitted thereinto is placed in the protruding portion 52. That is, the first lens 21 is secured in position in the direction of the optical axis by the protruding portion 52. Then, the outer circumference part of the first lens 21 is fixed by a swaging portion 38 formed at the end of the first lens tube portion 31 at the object side L1.

At the imaging side L2 of the second lens tube portion 32, a fifth-lens housing portion 325 having a diameter smaller than that of an inner circumference 321 of the second lens tube portion 32 is formed to house the fifth lens 25.

The inner circumference 321 is provided with a plurality of center-adjustment protruding portions 322 at equal intervals in the circumferential direction, the center-adjustment protruding portions 322 being formed to protrude (formed to bulge) inward in the radial direction. The second and the third lenses 22, 23 among the lenses constituting the wide-angle lens 2 are pressed (typically, gently pressed) against the center-adjustment protruding portions 322, and their outer circumferences are supported by the inner circumference 321 (the center-adjustment protruding portions 322) of the second lens tube portion 32 so that they are secured in position in the radial direction.

The fourth lens 24, which is a lens element included in the cemented lens 26 and located at the object side L1, is placed on a circular placement surface 315 whose outer edge portion (edge area of the imaging-side flange outer circumference) at the imaging side L2 extends inward in the radial direction on the bottom of the second lens tube portion 32. That is, the fourth lens 24 is secured in position in the direction of an optical axis L by the placement surface 315 formed at the object side L1 of a bottom 341, described later, of the circumferential groove 34. Furthermore, the fourth lens 24 is pressed (typically, gently pressed) in the same manner as the second and the third lenses 22, 23. The fifth lens 25 is not in contact with the lens-tube main body 30 (the second lens tube portion 32 (the fifth-lens housing portion 325)).

Furthermore, a flat portion formed at the circumferential edge of the surface of the third lens 23 at the imaging side L2 is placed on a flat portion formed at the circumferential edge of the surface of the fourth lens 24 at the object side L1 through the aperture 5. Furthermore, a flat portion formed at the circumferential edge of the surface of the second lens 22 at the imaging side L2 is placed on a flat portion formed at the circumferential edge of the surface of the third lens 23 at the object side L1 through the light shielding plate 6. Moreover, the circumferential edge of the surface of the second lens 22 at the object side L1 is engaged with a swaging portion 37 provided at the end of the inner circumference of the second lens tube portion 32 at the object side.

With this configuration, the second lens 22 to the fifth lens 25 are secured in position in the direction of the optical axis L with the placement surface 315 as a reference.

### Shape of the Circumferential Groove 34

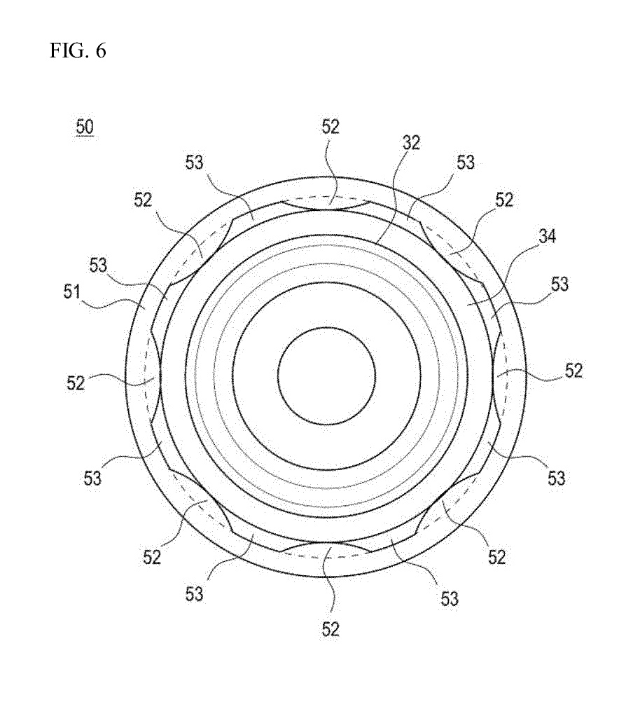

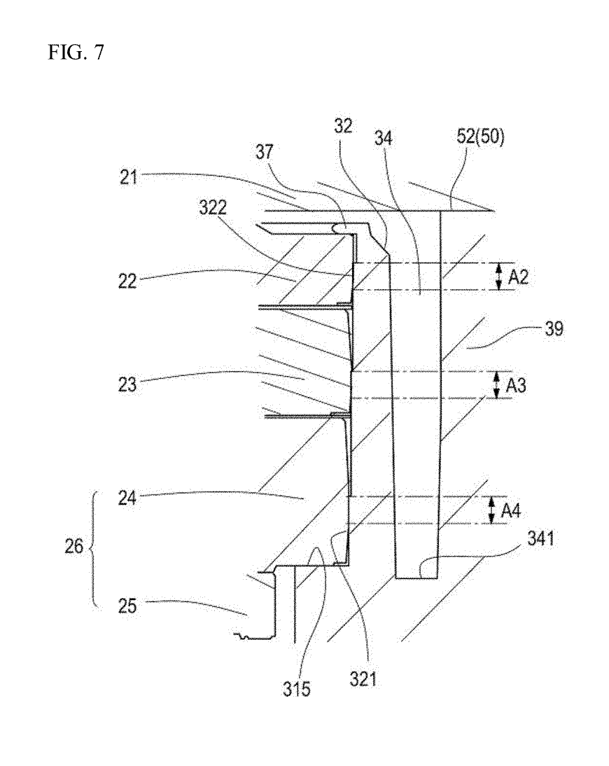

Next, with reference to FIG. 6 and FIG. 7, the circumferential groove 34 and the bottom 50 of the first lens tube portion 31 are explained in more detail.

FIG. 6 is a diagram that shows the bottom 50 of the first lens tube portion 31 when viewed from the object side L1. As described above, the bottom 50 of the first lens tube portion 31 is provided with the protruding portions (bulging portions) 52 protruding toward the circumferential groove 34 (i.e., inward in the radial direction) from the circular flat surface 51 at the inner circumference side. Here, the eight protruding portions 52 having a shape like a circular protrusion when viewed from the object side L1 are formed at equal intervals in the circumferential direction. The degree of protrusion is appropriate if the first lens 21 may be properly fixed when it is placed and secured with the swaging portion 38. Here, the degree of protrusion of the protruding portion 52 may be such that the protruding portion 52 protrudes beyond an end 38a of the swaging portion 38 after the first lens 21 is swaged and fixed. This prevents effects on the optical performance due to the occurrence of distortion of the first lens 21 caused by the swaging stress applied to the first lens 21 during swaging and fixing. Moreover, the shape of the protruding portion 52 needs to be not only a shape like a circular protrusion but also a rectangle or any other shapes as long as it performs a function to place the first lens 21 in position.

Furthermore, the deep circumferential groove 34 increases loads on a circular mold for molding the circumferential groove 34. Therefore, there is a possibility that, when the lens tube 3 is removed (taken out) from the mold after molding, it is hard to remove the lens tube 3 and therefore it is difficult to form the circumferential groove 34 (particularly, the side of the second lens tube portion 32 (i.e., the inner side of the circumferential groove 34)) with high accuracy. That is, there is a possibility that it is difficult to ensure the roundness of the lens chamber (the inner circumference 321) of the second lens tube portion 32. Furthermore, as it is difficult to ensure the thickness of a circular mold, the operating life of the mold may be short. Therefore, the provision of the recessed portion 53 ensures the thickness of the circular mold for molding the circumferential groove 34, makes the lens tube 3 easily removed when the lens tube 3 is removed (taken out) from the mold after molding, and enables molding of the circumferential groove 34 (particularly, the side of the second lens tube portion 32 (i.e., the inner side of the circumferential groove 34)) with high accuracy. Thus, the roundness of the lens chamber (the inner circumference 321) of the second lens tube portion 32 may be ensured. Furthermore, as the thickness of the circular mold may be ensured, the operating life of the mold may be longer.

FIG. 7 is a diagram that shows a cross-sectional structure of the circumferential groove 34, and it shows an area X of FIG. 4 in an enlarged manner. As described above, the second lens tube portion 32 houses the second to the fifth lenses 22 to 25. The outer edge part of the fourth lens 24 at the imaging side L2 is placed on the circular placement surface 315 extending inward in the radial direction on the bottom of the second lens tube portion 32. Here, the side surface part of the fourth lens 24 is pressed against and held by a predetermined press area A4 of the center-adjustment protruding portion 322 formed in the inner circumference 321 so that it is secured in position in the radial direction. Furthermore, a configuration may be such that the fourth lens 24 is inserted and fixed in the press area A4 with a force not enough to be pressed (i.e., a power enough to prevent backlash).

A flat portion formed at the circumferential edge of the surface of the third lens 23 at the imaging side L2 is placed on a flat portion formed at the circumferential edge of the surface of the fourth lens 24 at the object side L1 through the aperture 5. Here, the side surface part of the third lens 23 is pressed against and held by a predetermined press area A3 of the center-adjustment protruding portion 322 formed on the inner circumference 321. Furthermore, a flat portion formed at the circumferential edge of the surface of the second lens 22 at the imaging side L2 is placed on a flat portion formed at the circumferential edge of the surface of the third lens 23 at the object side L1 through the light shielding plate 6. Here, the side surface part of the second lens 22 is pressed against and held by a predetermined press area A2 of the center-adjustment protruding portion 322 in the same manner as the third lens 23. Furthermore, the second lens 22 and the third lens 23 may be fixed by being held with a force not enough to be pressed in the same manner as the fourth lens 24.

The circumferential groove 34 formed on the bottom 50 of the first lens tube portion 31 is recessed to a position deeper than the placement surface 315 on which the fourth lens 24 contained in the second lens tube portion 32 is placed. That is, the bottom 341 of the circumferential groove 34 is in a position deeper than the placement surface 315.

Here, a problem may occur if the lens chamber (the inner circumference 321) of the second lens tube portion 32 having the second to the fifth lenses 22 to 25 contained therein has low roundness. For example, there is a possibility that the lens form of the fourth lens 24 is distorted due to eccentricity and it is separated from the fifth lens 25 at their joint. Furthermore, although the aperture 5 is disposed between the fourth lens 24 and the third lens 23, the optical property is largely affected by eccentricity between the fourth lens 24 and the third lens 23 if the lens chamber of the second lens tube portion 32 has low roundness at the area (the press area A4) that abuts the fourth lens 24. Furthermore, the optical property is largely affected by eccentricity between the fourth lens 24 and the third lens 23 if the lens chamber of the second lens tube portion 32 has low roundness at the area (the press area A3) against which the third lens 23 is pressed. Moreover, the optical property is largely affected by eccentricity between the second lens 22 and the third lens 23 if the lens chamber of the second lens tube portion 32 has low roundness at the area (the press area A2) against which the second lens 22 is pressed. Thus, the roundness of the lens chamber of the second lens tube portion 32 at the pressing or abutting area is of particular importance.

To improve the roundness of the lens chamber in the second lens tube portion 32, it may be helpful to prevent the occurrence of sink marks of resin. To prevent the occurrence of sink marks, the thickness of the second lens tube portion 32 (the thickness of the inner circumference 321 of the second lens tube portion 32 and the outer circumference of the lens tube 3) needs to be appropriate. That is, the thick second lens tube portion 32 easily causes sink marks. Furthermore, the thin second lens tube portion 32 causes a low filling density, which easily causes the occurrence of sink marks and deformation. In this aspect, formation of the circumferential groove 34 may reduce the thickness of the lens-tube main body 30 (specifically, the second lens tube portion 32), thereby preventing the occurrence of sink marks. Furthermore, to increase the filling density of resin at a specific area (here, the second lens tube portion 32), an injection pressure during molding is high and a gate (gate port) for injecting resin during molding of the lens tube 3 is located near the specific area. However, for example, when the gate (gate port) for injecting resin during molding of the lens tube 3 is located near the specific area, the flow path of resin is narrow due to formation of the circumferential groove 34, and therefore a residual stress due to resin injection molding is likely to be high as compared to a case where the circumferential groove 34 is not formed. Thus, the accuracy (roundness) of the specific area is easily affected by the residual stress as the gate is located near the specific area. Therefore, a high injection pressure during molding and a gate position away from a specific area enable a moderate flow of resin as well as a high injection pressure. As a result, a residual stress may be low at a specific area even when the circumferential groove 34 is formed, and thus the roundness of the lens chamber in the second lens tube portion 32 may be improved.

Especially, as described above, as the gate position is in the neighborhood of the end of the skirt portion 33 of the lens tube 3 at the imaging side L2 and is away from the second lens tube portion 32, the flow of resin in the second lens tube portion 32, whose roundness is of importance, may be moderate, whereby a high degree of roundness may be achieved. That is, the gate mark 35 indicating the resin injection position and formed when the lens tube 3 is molded is formed outward in the radial direction from the circumferential groove 34 formed in the lens tube 3 (the lens-tube main body 30).

Furthermore, with regard to the placement surface 315 on which the fourth lens 24 is placed, the occurrence of sink marks is suppressed so that a decrease in the surface accuracy is preventable.

### Primary Characteristics of the Present Embodiment

The brief summary of the characteristics of the present embodiment is as follows:

(1) The lens unit 1 includes: the first lens 21 located closest to the object side; the plurality of lenses (the second to the fifth lenses 22 to 25) located at the imaging side L2 of the first lens 21; and the lens tube 3 holding the first lens 21 and the plurality of lenses (the second to the fifth lenses 22 to 25), the lens tube 3 includes: the first lens tube portion 31 holding the first lens 21; and the second lens tube portion 32 holding the plurality of lenses (the second to the fifth lenses 22 to 25), the lens tube 3 is provided with the circumferential groove 34 recessed between the inner circumference 321 of the second lens tube portion 32 and the outer circumference of the lens tube 3 and extending from the object side toward the imaging side, and, when viewed in the direction perpendicular to the optical axis L, the bottom 341 of the circumferential groove 34 is located at the imaging side L2 in a depth that is more than the thickness of the second lens 22 in the direction of the optical axis, the second lens 22 being located closest to the object side among the plurality of lenses (the second to the fifth lenses 22 to 25).

As the circumferential groove 34 extending from the object side L1 is formed, spaces in the lens tube 3 at the imaging side may be ensured. Therefore, spaces for alignment with a higher-level device, such as an imaging device, may be ensured, and it is possible to cope with a demand for a size reduction. Moreover, as the circumferential groove 34 extending from the object side L1 is formed and the bottom 341 of the circumferential groove 34 is located at the imaging side L2 in a depth that is more than the thickness of at least the second lens 22 in the direction of the optical axis, sink marks in the part holding the second lens 22 in the second lens tube portion 32 may be prevented, and a higher resolution may be achieved.

(2) The plurality of lenses (the second to the fifth lenses 22 to 25) held by the second lens tube portion 32 are swaged and fixed in the direction of the optical axis by the swaging portion 37 formed at the end of the second lens tube portion 32. With this configuration, the plurality of lenses (the second to the fifth lenses 22 to 25) are secured in position in the direction of the optical axis by the swaging portion 37, whereby positional deviations in the direction of the optical axis may be prevented.

(3) The lenses include: the second lens 22; the third lens 23 located the second closest to the object side after the second lens 22; and the imaging-side lenses (the fourth lens 24, the fifth lens 25) located at the imaging side of the third lens 23, and the bottom 341 of the circumferential groove 34 is located at the imaging side L2 in a depth that is more than the thickness of the third lens 23 in the direction of the optical axis.

(4) The gate mark 35 formed when the lens tube 3 is produced and indicating the resin injection position is formed outward of the circumferential groove 34 in the radial direction, and the bottom 341 of the circumferential groove 34 is located at the imaging side of the press area A4 of the lens that is located closest to the imaging side L2 among the plurality of lenses (the second to the fifth lenses 22 to 25) and pressed into the inner circumference 321 of the second lens tube portion 32.

With this configuration, it is possible to prevent unevenness of resin when the press areas A2, A3 for the lenses are directly affected by the flow of resin during injection molding. That is, the accuracy of the roundness of the second lens tube portion 32 may be improved.

(5) The plurality of lenses (the second to the fifth lenses 22 to 25) disposed on the inner side of the circumferential groove 34 are secured in position in the direction of the optical axis by the placement surface 315 that is formed at the object side L1 of the bottom 341 of the circumferential groove 34.

As the placement surface 315 is located at the object side L1 of the bottom 341 of the circumferential groove 34, it is possible to prevent a reduction in the surface accuracy of the placement surface due to sink marks, or the like.

(6) The first lens tube portion 31 includes the protruding portions 52 protruding toward the side of the circumferential groove 34 (i.e., the side in the radial direction), and the first lens 21 is secured in position by the protruding portion 52.

(7) The lens tube 3 is formed by integrating the chassis and the lens holder.

(8) The gate mark 35 is formed in the neighborhood of the end of the outer frame of the lens tube 3 at the imaging side L2 (here, in the neighborhood of the end of the skirt portion 33). This allows a longer distance between the second lens tube portion 32 and the gate, through which resin is injected during resin molding, so that the flow of resin in the second lens tube portion 32 is equalized.

### OTHER EMBODIMENTS

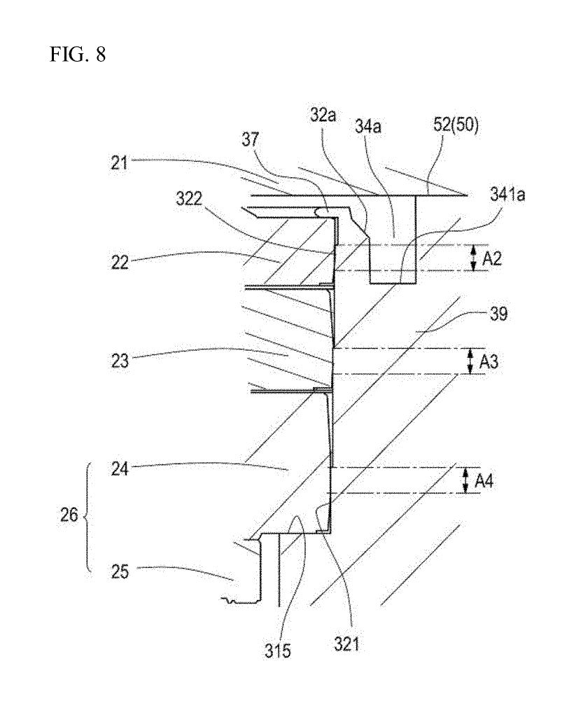

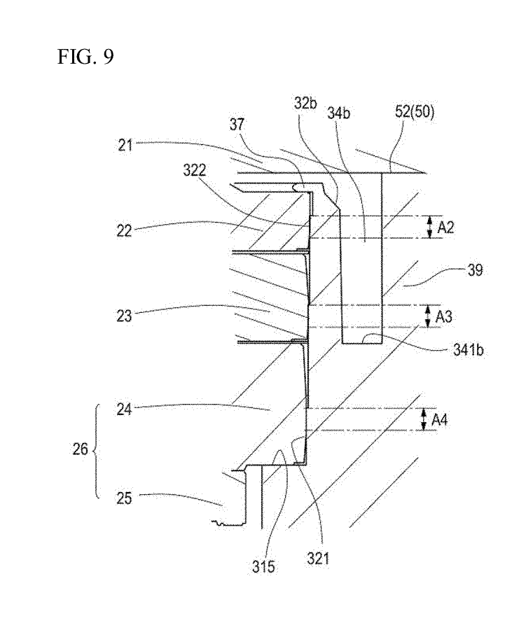

Next, other embodiments (modifications 1 to 4) are explained. FIG. 8 is a cross-sectional view showing a modification 1, and FIG. 9 is a cross-sectional view showing a modification 2. They are modifications of the configuration shown in FIG. 7. In other embodiments, as the basic configuration is the same as that in the above-described embodiment, the same parts are attached with the same reference numeral, and their explanations are omitted.

According to the modification 1, the depth of a circumferential groove 34a is different from that in the example of FIG. 7. Here, a bottom 341a is provided at a position deeper than the press area A2 for the second lens 22, here, a position at the imaging side L2 in a depth that is more than the thickness of the second lens 22 in the direction of the optical axis, more specifically, a position at the boundary between the third lens 23 and the second lens 22. With this configuration, the accuracy of the roundness of the lens chamber housing the pressed second lens 22 in a second lens tube portion 32a may be improved. Particularly, this configuration is applicable when the second lens 22 is tightly pressed and the third lens 23 and the fourth lens 24 are gently pressed (or held with power enough to prevent backlash).

According to the modification 2, the depth of a circumferential groove 34b is different from that in the example of FIG. 7. Specifically, the configuration is such that, out of the second lens 22 to the fifth lens 25 contained in a second lens tube portion 32b, the second lens 22 and the third lens 23 are pressed. Furthermore, a bottom 341b is provided at a position deeper than the press area A3 for the third lens 23, here, a position at the imaging side L2 in a depth that is more than the thickness of the third lens 23 in the direction of the optical axis, more specifically, a position at the boundary between the third lens 23 and the fourth lens 24. With this configuration, the accuracy of the roundness of the lens chamber housing the second lens 22 and the third lens 23 pressed into the second lens tube portion 32b may be improved. Particularly, this configuration is applicable when the second lens 22 and the third lens 23 are tightly pressed and the fourth lens 24 is gently pressed (or held with power enough to prevent backlash).

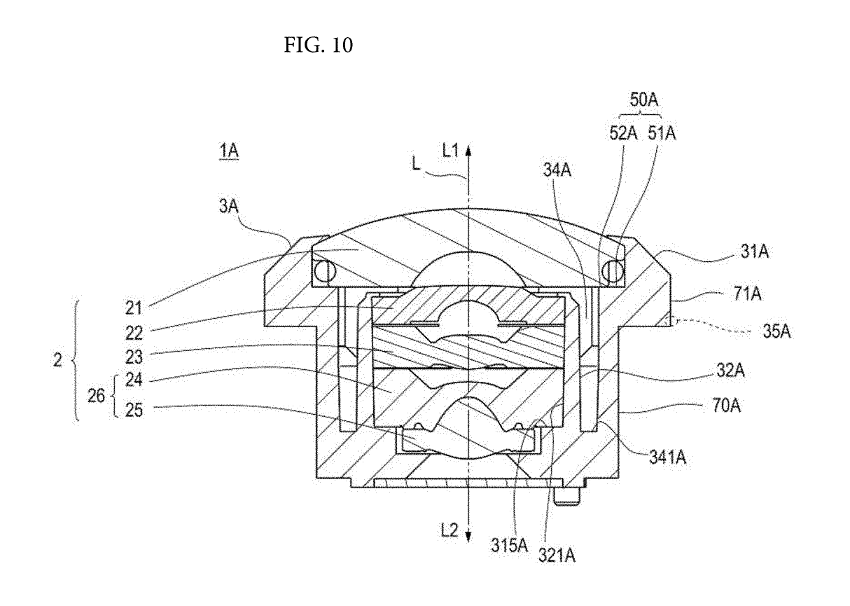

FIG. 10 is a longitudinal sectional view of a lens unit 1A according to the modification 3. It is different from the above-described embodiment in that a lens tube 3A has a cylindrical shape of only a lens holder and it does not have the structure/function of a lens chassis. That is, it has a structure such that what is called a lens holder and a chassis are separate members. The lens tube 3A includes a first lens tube portion 31A at the object side L1 and a second lens tube portion 32A at the imaging side L2 that are integrally formed.

A bottom 50A of the first lens tube portion 31A is provided with a flat surface 51A and a protruding portion 52A protruding from the flat surface 51A. The first lens 21 is placed on the protruding portion 52A and is swaged and fixed. The second to the fifth lenses 22 to 25 are housed in the second lens tube portion 32A and are swaged and fixed.

A circumferential groove 34A recessed between an inner circumference 321A of the second lens tube portion 32A and an outer circumference 70A of the lens tube 3 and extending from the object side L1 toward the imaging side L2 is formed in a predetermined depth, i.e., to a position at the imaging side L2 slightly lower than a placement surface 315A formed on the bottom of the second lens tube portion 32A. Furthermore, the outer circumference 70A of the lens tube 3 is provided with a flange portion 71A having a larger diameter at the imaging side L2 than at the object side L1. At areas of the flange portion 71A at the imaging side L2, two gate marks 35A are formed at equal intervals in the circumferential direction. With this configuration, the same advantage as that of the above-described embodiment is obtained. That is, as there is an enough distance between the gate port (the gate mark 35A) and the second lens tube portion 32A, the flow of resin injected during injection molding may be equalized, and the accuracy of the roundness of the second lens tube portion 32A may be improved. Furthermore, as resin injected through the gate port (the gate mark 35A) is not brought into direct contact with the area where the second lens tube portion 32A is formed, the flow of resin in the area may be stabilized, and a reduction in the accuracy of the roundness may be prevented. Although the two gate marks 35A are formed at equal intervals in the circumferential direction, a configuration may be such that the single gate mark 35A is formed in the circumferential direction or the three or more gate marks 35A are formed at equal intervals in the circumferential direction.

The structures of the circumferential groove and the lens tube at the side of the optical axis L of the circumferential groove are principally described above. However, an explanation is given below of the modification 4 in which the structure of the lens tube outside the circumferential groove is changed from that in the embodiment.

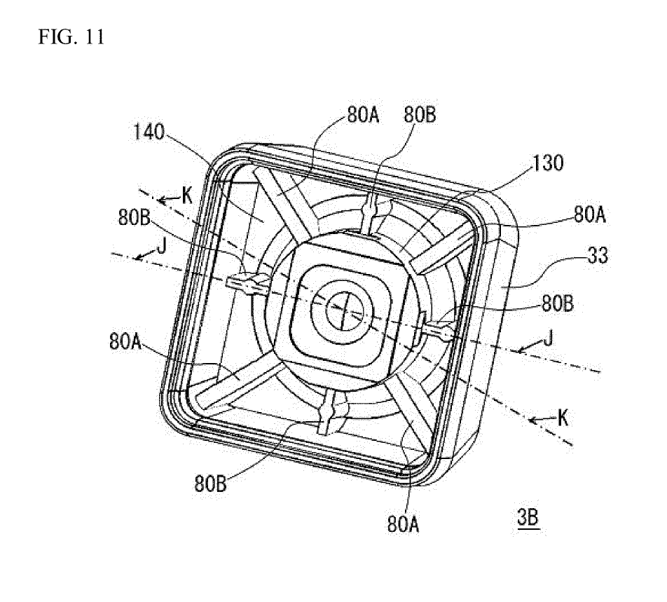

FIG. 11 is a perspective view showing the structure of a lens tube 3B used in the modification 4 when viewed from near the imaging side L2. As is the case with the lens tube 3 shown in FIG. 1, and the like, the lens tube 3B is also provided with the first lens tube portion 31 and the second lens tube portion 32, and the circumferential groove 34 is formed in the same manner. Furthermore, the skirt portion 33 having substantially a rectangular shape in cross-section perpendicular to the optical axis L is provided so as to surround a lens-tube main body 130 around the optical axis L. Moreover, a top board portion 140 having a larger diameter than that of the lens-tube main body 130 is connected to the lens-tube main body 130 at the object side L1, and the lens-tube main body 130 is connected to the skirt portion 33 at the object side L1 through the top board portion 140 so that they are integrated with each other.

Here, as shown in FIG. 11, inside the skirt portion 33, four plate-like ribs 80A, 80B are formed on diagonal lines of the substantially rectangular shape and straight lines connecting the centers of opposing sides thereof, the ribs 80A, 80B extending on the plane including the optical axis L. Each of the ribs 80A, 80B is formed such that it connects, along the radial direction, the skirt portion 33 at the outer side in the radial direction and the lens-tube main body 130 at the inner side in the radial direction. Furthermore, the ribs 80A, 80B connect the top board portion 140, the skirt portion 33, and the lens-tube main body 130 at the object side L1 inside the skirt portion 33.

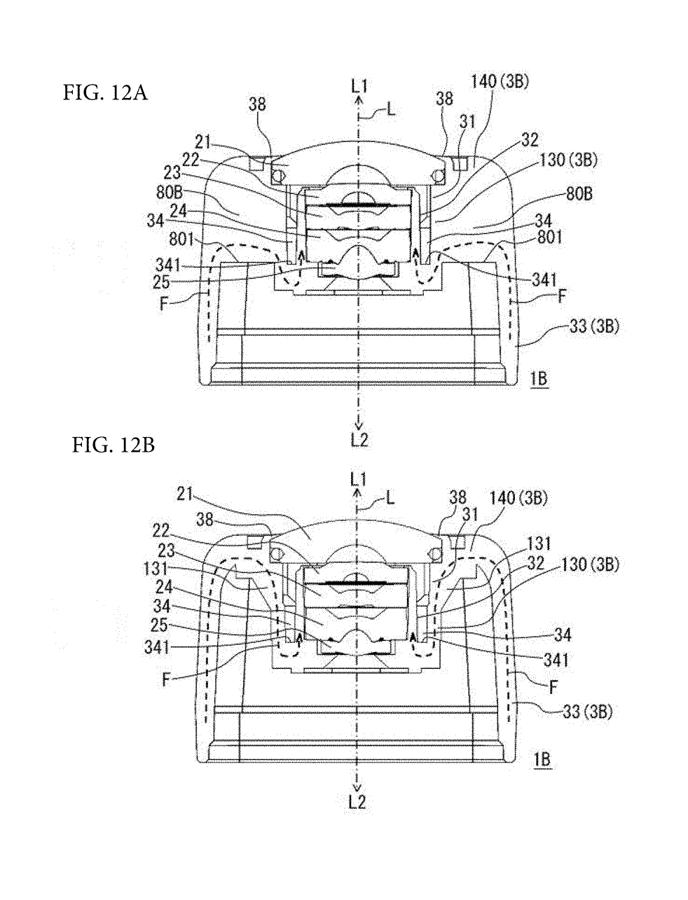

FIGS. 12A and 12B show a lens unit 1B using the lens tube 3B in cross-section (in cross-section of the area where the rib 80B is provided along the optical axis L) in the J-J direction of FIG. 11 and in cross-section (in cross-section of the area where the ribs 80A, 80B are not provided along the optical axis L) in the K-K direction, respectively. As described above, as the structure of the lens tube 3B at the inner side of the circumferential groove 34 in the radial direction is the same as that of the above-described lens tube 3, the first lens 21 to the fifth lens 25 are secured to the lens tube 3B in the same manner as the lens unit 1.

In actuality, the lens tube 3B is obtained by partially forming a recess extending from the imaging side L2 in the area on the outer side of the circumferential groove 34 (the outer side of the lens-tube main body 130) in the lens tube 3 shown in FIG. 3. Therefore, the areas where a recess is not formed are the ribs 80A, 80B, and the structure in FIG. 12A showing the cross-section of the area where the rib 80B is provided is the same as the structure in FIG. 3. Thus, in FIG. 12A, the bottom (a rib bottom 801) of the rib 80B is located on the uppper side (the object side L1) of the bottom of the lens-tube main body 130 in the drawing. The same holds for the cross-section of the area where the rib 80A is provided, including the optical axis L.

Due to lightening conducted to provide the above-described ribs 80A, 80B or form the ribs 80A, 80B, the lens tube 3B (the lens unit 1B) is lightweight and the mechanical strength is maintainable. To reduce the weight by forming a large recessed portion while the mechanical strength of the lens tube 3B is sufficiently maintained, the ribs 80A, 80B may be formed at four areas in diagonal lines of the substantially rectangular shape and the lines conencting the centers of opposing sides thereof, as shown in FIG. 11. This decreases a reduction in the strength due to lightening conducted.

Furthermore, with regard to the lens tube 3B, the first lens 21 is fixed to the lens tube 3B with the swaging portion 38 in the same manner as the lens tube 3. In FIG. 12B, the swaging portion 38 is present in the top board portion 140 on the outer side of the circumferential groove 34 in the radial direction and, when the first lens 21 is fixed, a force is applied to a thinned part, or the like, on the outer side of the circumferential groove 34 in the lens-tube main body 130. Furthermore, as described above, a part on the outer side of the circumferential groove 34 in the lens-tube main body 130 is evenly thin to prevent sink marks during molding.

In the structure in which the ribs 80A, 80B are provided to thus reinforce a part to which a force is applied during swaging processing, as shown in FIG. 12B that is the cross-section of the area where the ribs 80A, 80B are not provided, a tilted portion 131 is provided in the lens-tube main body 130 at the object side L1 along its outer diameter such that, in the lens-tube main body 130, its outer diameter gradually spreads toward the side of the swaging portion 38 (or the side of the top board portion 140: the object side L1). That is, the lens tube 3B is obtained by forming a recess in the lens tube 3 to form the ribs 80A, 80B and the tilted portion 131. Thus, the lens tube 3B at areas where the ribs 80A, 80B are not provided is reinforced against a force applied particularly during swaging processing.

Furthermore, as shown in FIG. 12B, the tilted portion 131 provided in the lens-tube main body 130 only at the object side L1, and at the imaging side L2 thereof, the outer side of the circumferential groove 34 in the lens-tube main body 130 is uniformly thin. As the tilted portion 131 is provided and a part on the outer side of the circumferential groove 34 in the lens-tube main body 130 is uniformly thin, the occurrence of sink marks is prevented and, when the ribs 80A, 80B are provided (the thickness is reduced), a part, or the like, to which a force is applied during swaging processing may be reinforced. Alternatively, even when the first lens 21 is fixed not by swaging processing, the provision of the tilted portion 131 reinforces the part connecting the ribs 80A, 80B, the top board portion 140, and the lens-tube main body 130.

Furthermore, the provision of the ribs 80A, 80B affects manufacturing of the lens tube 3B by resin molding. As described above, the gate port (equivalent to the gate mark 35) for molding is disposed in the skirt portion 33 at the outer side and at the imaging side L2 in FIG. 12A and FIG. 12B. Therefore, as indicated by the arrow in FIG. 12A and FIG. 12B, the flow of resin F at the time of injection of resin into the mold is such that resin flows from the lower side in the drawing (the imaging side L2) of the skirt portion 33 located on the outer side in the radial direction to the upper side in the drawing (the object side L1) and then flows toward the second lens tube portion 32 located on the inner side in the radial direction.

Here, for desirable molding, as described above, a longer path length from the gate port is effective in equalizing the flow of resin. In FIG. 12B, lightening processing makes the path for the flow of resin F uniformly narrow and makes long the path length in which the flow reaches the upper end side in the drawing. Conversely, in FIG. 12A, the presence of the rib 80B does not make the width of the path for the flow of resin F uniform along the flow, that is, the width of the path becomes considerably wide at the area of the rib 80B, and the path length is shorter than that in FIG. 12A. Thus, the provision of the rib 80B disturbs homogenization of the flow.

However, in FIG. 12A, a configuration is such that the bottom (the rib bottom 801) of the rib 80B is located at the imaging side L2 of the bottom 341 of the circumferential groove 34. This allows, in FIG. 12A, a long path length for the flow of resin F as the flow of resin F temporarily leads to a lower side at the area of the rib 80B and then leads to an upper side. The same holds for the area of the rib 80A. This reduces the difference in the path length as compared to the case in FIG. 12B, prevents turbulence in the flow of resin, and enables desirable molding. Thus, the roundness of the inner circumference (the second lens tube portion 32, or the like) of the lens tube 3B may be improved even when the ribs 80A, 80B are provided.

The characteristics of the lens tube 3B used in the modification 4 are as follows:

(1) The lens tube 3B includes: the lens-tube main body 130 including the first lens tube portion 31 and the second lens tube portion 32 and having the circumferential groove 34 formed therein; the top board portion 140 connecting to the lens-tube main body 130 at the object side L1; and the skirt portion 33 connecting to the top board portion 140 and surrounding the lens-tube main body 130 around the optical axis L in the direction thereof at the imaging side L2 of the top board portion 140. The plate-like ribs 80A, 80B connecting the top board portion 140, the skirt portion 33, and the lens-tube main body 130 at the imaging side L2 of the top board portion 140 and including the rib bottom 801 located at the object side L1 of the bottom of the lens-tube main body 130 are separately formed at multiple areas in the circumferential direction around the the optical axis L.

(2) The skirt portion 33 has an inner surface having substantially a rectangular shape when viewed in the direction of the optical axis L, and the ribs 80A, 80B are formed along diagonal lines of the substantially rectangular shape and straight lines connecting the opposing sides thereof when viewed in the direction of the optical axis L.

This lightening conducted on the lens tube 3B to form the ribs 80A, 80B makes the lens tube 3B and the lens unit 1B lightweight while the ribs 80A, 80B maintain the mechanical strength of the lens tube 3B.

(3) In the area where the ribs 80A, 80B are not provided when viewed in the direction of the optical axis L, the lens-tube main body 130 is provided with, at the object side L1 of the rib bottom 801, the tilted portion 131 in which the outer diameter of the lens-tube main body 130 is gradually larger as it approaches toward the top board portion 140 than at the imaging side L2.

The tilted portion 131 thus formed in the lens-tube main body 130 reinforces the part connecting the ribs 80A, 80B, the lens-tube main body 130, and the top board portion 140. This reinforcement is particularly effective in fixing the first lens 21 with the swaging portion 38 during swaging processing.

(4) The rib bottom 801 is located at the object side L1 of the bottom 341 of the circumferential groove 34.

The rib bottom 801 located at the object side L1 of the bottom 341 of the circumferential groove 34 enables a long path for the flow of resin and suppresses turbulence in the flow of resin during molding of the lens tube 3B even when the ribs 80A, 80B are provided. Thus, the roundness of the inner circumference (the second lens tube portion 32, or the like) of the lens tube 3B may be improved even when the ribs 80A, 80B are provided.

Furthermore, in a lens tube, ribs may be formed on rather than the diagonal lines of the substantially rectangular shape and the straight lines connecting the centers of opposing sides thereof. In this case, when viewed in the direction of the optical axis L, a rib is disposed along the straight line passing through the optical axis L. An area for providing a rib may be set as needed in accordance with the shape of the inner surface of the skirt portion. Moreover, the shape of the rib may be not only a simple plate-like shape but also a shape such that its thickness changes in the direction of the optical axis L or its thickness changes in the radial direction. Here, the shape of a rib may be set for desirable molding of a lens tube.

At least an embodiment of the present invention is explained based on the embodiment and the modifications; however, it is understood by a person skilled in the art that, as the embodiments and the modifications are presented as examples, various modifications may be made with a combination of components, or the like, and those modifications are also included in the scope of the present invention. For example, the thick-walled portion 39 of the lens tube 3 shown in FIG. 2 to FIG. 5 may be provided with a groove having a recess extending from the imaging side L2 toward the object side L1.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A lens unit comprising:
a first lens located closest to an object side;
a plurality of lenses located at an imaging side of the first lens; and
a lens tube holding the first lens and the plurality of lenses, wherein
the lens tube comprises a first lens tube portion holding the first lens and a second lens tube portion holding the plurality of lenses,
the lens tube comprises a circumferential groove recessed between an inner circumference of the second lens tube portion and an outer circumference of the lens tube and extending from the object side toward the imaging side, and
when viewed in a direction perpendicular to an optical axis, a bottom of the circumferential groove is located at the imaging side in a depth that is more than a thickness of a second lens in a direction of the optical axis, the second lens being located closest to the object side among the plurality of lenses.

2. The lens unit according to claim 1, wherein the plurality of lenses held by the second lens tube portion is swaged and fixed by a swaging portion formed at an end of the second lens tube portion in the direction of the optical axis.

3. The lens unit according to claim 1, wherein
the plurality of lenses comprises the second lens, a third lens located second closest to the object side after the second lens, and an imaging-side lens located at the imaging side of the third lens, and
a bottom surface of the circumferential groove is located at the imaging side in a depth that is more than a thickness of the third lens in the direction of the optical axis.

4. The lens unit according to claim 1, wherein
a gate mark formed when the lens tube is produced and indicating an injection position of resin is formed outward of the circumferential groove in a radial direction, and
the bottom of the circumferential groove is located at the imaging side of a press area of a lens that is located closest to the imaging side among the plurality of lenses and pressed into the inner circumference of the second lens tube portion.

5. The lens unit according to claim 1, wherein the plurality of lenses located on an inner side of the circumferential groove is secured in position in the direction of the optical axis by a placement surface formed at the object side of the bottom surface of the circumferential groove.

6. The lens unit according to claim 1, wherein the first lens tube portion comprises a protruding portion that protrudes toward the circumferential groove, and the first lens is secured in position by the protruding portion.

7. The lens unit according to claim 1, wherein the lens tube is formed by integrating a chassis and a lens holder.

8. The lens unit according to claim 1, wherein
the lens tube comprises:
a lens-tube main body comprising the first lens tube portion and the second lens tube portion and having the circumferential groove formed therein;
a top board portion connected to the lens-tube main body at the object side;
a skirt portion surrounding the lens-tube main body around the optical axis in a direction thereof at the imaging side of the top board portion and connected to the top board portion; and
a plurality of plate-like ribs connecting the top board portion, the skirt portion, and the lens-tube main body at the imaging side of the top board portion and comprising a rib bottom that is located at the object side of a bottom of the lens-tube main body, the ribs being separately formed at areas in a circumferential direction around the optical axis.

9. The lens unit according to claim 8, wherein
the skirt portion has an inner surface having substantially a rectangular shape when viewed in the direction of the optical axis, and
when viewed in the direction of the optical axis, the ribs are formed along at least a diagonal line of the substantially rectangular shape and a straight line connecting centers of opposing sides.

10. The lens unit according to claim 8, wherein, in an area where the rib is not formed when viewed in the direction of the optical axis, the lens-tube main body comprises, at the object side of the rib bottom, a tilted portion in which an outer diameter of the lens-tube main body is gradually larger as approaching toward the top board portion than at the imaging side.

11. The lens unit according to claim 8, wherein the rib bottom is located at the object side of the bottom of the circumferential groove.

12. The lens unit according to claim 1, wherein a gate mark is formed near an end of an outer frame of the lens tube at the imaging side, the gate mark being formed when the lens tube is molded with resin.

13. The lens unit according to claim 2, wherein
the lens tube comprises:
a lens-tube main body comprising the first lens tube portion and the second lens tube portion and having the circumferential groove formed therein;
a top board portion connected to the lens-tube main body at the object side;
a skirt portion surrounding the lens-tube main body around the optical axis in a direction thereof at the imaging side of the top board portion and connected to the top board portion; and
a plurality of plate-like ribs connecting the top board portion, the skirt portion, and the lens-tube main body at the imaging side of the top board portion and comprising a rib bottom that is located at the object side of a bottom of the lens-tube main body, the ribs being separately formed at areas in a circumferential direction around the optical axis.

14. The lens unit according to claim 13, wherein, in an area where the rib is not formed when viewed in the direction of the optical axis, the lens-tube main body comprises, at the object side of the rib bottom, a tilted portion in which an outer diameter of the lens-tube main body is gradually larger as approaching toward the top board portion than at the imaging side.

15. The lens unit according to claim 4, wherein the plurality of lenses located on an inner side of the circumferential groove is secured in position in the direction of the optical axis by a placement surface formed at the object side of the bottom surface of the circumferential groove.

16. The lens unit according to claim 15, wherein
the lens tube comprises:
a lens-tube main body comprising the first lens tube portion and the second lens tube portion and having the circumferential groove formed therein;
a top board portion connected to the lens-tube main body at the object side;
a skirt portion surrounding the lens-tube main body around the optical axis in a direction thereof at the imaging side of the top board portion and connected to the top board portion; and
a plurality of plate-like ribs connecting the top board portion, the skirt portion, and the lens-tube main body at the imaging side of the top board portion and comprising a rib bottom that is located at the object side of a bottom of the lens-tube main body, the ribs being separately formed at areas in a circumferential direction around the optical axis.

17. The lens unit according to claim 16, wherein the rib bottom is located at the object side of the bottom of the circumferential groove.

18. The lens unit according to claim 5, wherein
the lens tube comprises:
a lens-tube main body comprising the first lens tube portion and the second lens tube portion and having the circumferential groove formed therein;
a top board portion connected to the lens-tube main body at the object side;
a skirt portion surrounding the lens-tube main body around the optical axis in a direction thereof at the imaging side of the top board portion and connected to the top board portion; and
a plurality of plate-like ribs connecting the top board portion, the skirt portion, and the lens-tube main body at the imaging side of the top board portion and comprising a rib bottom that is located at the object side of a bottom of the lens-tube main body, the ribs being separately formed at areas in a circumferential direction around the optical axis.

19. The lens unit according to claim 18, wherein the rib bottom is located at the object side of the bottom of the circumferential groove.
